(19) United States
(12) Patent Application Publication
(10) Pub. No.: US 2020/0271299 A1
(43) Pub. Date: Aug. 27, 2020

(54) LIGHT EMITTING DEVICE

(71) Applicant: SHARP KABUSHIKI KAISHA, Sakai City (JP)

(72) Inventors: HIROAKI ONUMA, Sakai City (JP); TOSHIO HATA, Sakai City (JP); YASUAKI HIRANO, Sakai City (JP)

(21) Appl. No.: 16/791,792

(22) Filed: Feb. 14, 2020

Related U.S. Application Data
(60) Provisional application No. 62/808,568, filed on Feb. 21, 2019.

(51) Int. Cl. F21V 9/30; F21V 5/04; F21V 29/70

(52) U.S. Cl. CPC F21V 9/30; F21Y 2115/30; F21V 29/70; F21V 5/04

(57) ABSTRACT

A light emitting device includes at least a lens that emits light to the outside, a holder that supports the lens, and a wavelength conversion member and a semiconductor light source that are disposed inside the holder and a semiconductor light source on a side opposite to an emission surface of the lens, in which an inner wall of the holder between the lens and the wavelength conversion member includes a first step portion that covers an outer edge of the wavelength conversion member as seen from the lens side.

### BACKGROUND

### 1. Field

The present disclosure relates to a light emitting device that is a semiconductor light emitting device including a semiconductor laser as a light source, and in particular, is capable of emitting light converted by a wavelength conversion member with high-output.

### 2. Description of the Related Art

In general, a semiconductor light emitting device having a wavelength conversion member and an outer cap at a position separated from and facing a light transmitting body, and configured such that the outer cap formed with the wavelength conversion member includes a sealing cap outside the sealing cap is known. The semiconductor light emitting device is configured such that an optical axis of emission light and a central axis of the wavelength conversion member substantially coincide with each other (for example, refer to Japanese Unexamined Patent Application Publication No. 2008-305936 (published on Dec. 18, 2008))

By the way, it is difficult to obtain an emission color in a wavelength range of green to orange, in a range of 530 to 630 nm, with a single semiconductor light emitting element. A combination of a plurality of light emitting elements is a method for obtaining a desired emission color by the semiconductor light emitting element. For example, in order to obtain a yellow light emission, combining two of a green semiconductor light emitting element and a red semiconductor light emitting element to emit light at an appropriate intensity ratio is the method. Alternatively, a desired emission color can be freely obtained by combining three of a blue semiconductor light emitting element, a green semiconductor light emitting element, and a red semiconductor light emitting element, and appropriately changing each light emission intensity.

However, in a case where there is no need to change the emission color, it is unfavorable in cost to combine the plurality of light emitting elements. Accordingly, it is another method for obtaining a desired emission color, and there is an advantage in combining the light emitting semiconductor element and the wavelength conversion member as described in Japanese Unexamined Patent Application Publication No. 2008-305936 (published on Dec. 18, 2008). However, in a light emitting device that combines a semiconductor light emitting element and a wavelength conversion member, a so-called yellow ring phenomenon may occur in which the color differs between a central portion and an outer circumferential portion of an irradiation surface. In the light emitting device, it is preferable to suppress such a yellow ring as much as possible.

An embodiment of the present disclosure has been made in view of the above-described circumstances. It is desirable to provide the light emitting device that is capable of obtaining a desired emission color by combining the semiconductor light emitting element and the wavelength conversion member, and enabling the irradiation surface with a uniform color (reduction of yellow ring).

### SUMMARY

Provided is a light emitting device according to an embodiment of the present disclosure including at least a lens that emits light to the outside, a holder that supports the lens, and a wavelength conversion member and a semiconductor light source that are disposed inside the holder and a semiconductor light source on a side opposite to an emission surface of the lens, in which an inner wall of the holder between the lens and the wavelength conversion member includes a first step portion that covers an outer edge of the wavelength conversion member as seen from the lens side.

### BRIEF DESCRIPTION OF THE DRAWINGS

FIGS. 1A to 1C are cross-sectional diagrams of configurations of a light emitting device according to a first embodiment of the present disclosure.

FIG. 2 is a schematic diagram of a configuration of a semiconductor light source according to a first embodiment.

FIGS. 3A and 3B are cross-sectional diagrams schematically showing a wavelength conversion member according to a first embodiment, and FIG. 3A is an example and FIG. 3B is another example.

FIG. 4 is a flowchart of a method for manufacturing a light emitting device according to a first embodiment.

FIG. 5 is a cross-sectional diagram of a configuration of a light emitting device according to a second embodiment of the present disclosure.

FIG. 6 is a flowchart of a method for manufacturing a light emitting device according to a second embodiment.

FIG. 7 is a cross-sectional diagram of an example of a light emitting device according to a third embodiment.

FIG. 8 is a cross-sectional diagram of another example of a light emitting device according to a third embodiment.

FIG. 9 is a cross-sectional diagram of still another example of a light emitting device according to a third embodiment.

FIG. 10A is a top view schematic diagram of a light emitting device according to a third embodiment, FIG. 10B is an example of a cross-sectional diagram schematically showing a wavelength conversion member according to a third embodiment and FIG. 10C is another example.

FIGS. 11A and 11B are diagrams of modification examples of a wavelength conversion member.

FIG. 12 is a flowchart of a method for manufacturing a light emitting device according to a third embodiment.

FIG. 13 is a flowchart of a method for manufacturing a wavelength conversion member according to a third embodiment.

### DESCRIPTION OF THE EMBODIMENTS

### First Embodiment

Hereinafter, embodiments of the present disclosure will be described in detail.

### Configuration of Light Emitting Device 100

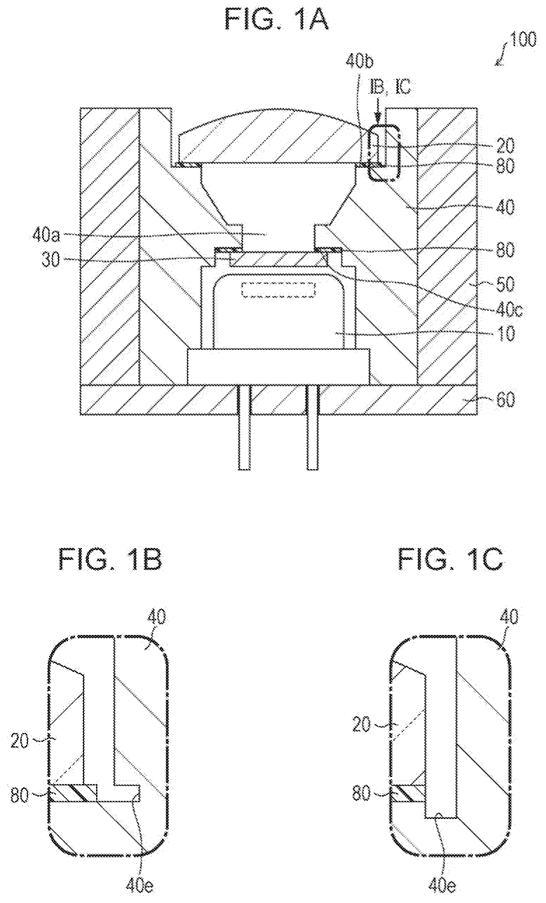

FIGS. 1A to 1C is cross-sectional diagrams of configurations of a light emitting device 100 according to a first embodiment of the present disclosure. The light emitting device 100 is a light emitting device 100 that can mostly emit white parallel light from a lens 20, and for example, is a high-output light emitting device that can be used for peak output, such as indoor and outdoor lighting, vehicle-mounted headlamps, and projectors. As shown in FIGS. 1A to 1C, the light emitting device 100 includes a semiconductor light source 10, a lens 20, a wavelength conversion member 30, a holder 40, a housing 50, and a heat radiating plate 60. The semiconductor light source 10, the lens 20, and the wavelength conversion member 30 are disposed inside a cylindrical holder 40 (inner diameter portion).

The semiconductor light source 10 may be a so-called TO-CAN package type light source device using a semiconductor light emitting element, in particular, a semiconductor laser (laser diode: LD) as a light source. As shown in FIGS. 1A to 1C, the semiconductor light source 10 is disposed inside a holder 40 which will be described later, on a side opposite to an emission surface of the lens 20 which will be described later.

The lens 20 is an optical member that concentrates an irradiation light from the semiconductor light source 10 to emit the light to the outside. As the lens 20, a biconvex lens can be suitably used. As shown in FIGS. 1A to 1C, the lens 20 is disposed above the semiconductor light source 10 and the wavelength conversion member 30 inside the cylindrical holder 40.

The wavelength conversion member 30 converts a wavelength of the irradiation light from the semiconductor light source 10. As shown in FIGS. 1A to 1C, the wavelength conversion member 30 is disposed between the semiconductor light source 10 and the lens 20 inside the cylindrical holder 40. In other words, the wavelength conversion member 30 is disposed inside the holder 40 on the side opposite to the emission surface of the lens 20. It is desirable that the wavelength conversion member 30 is provided at focal position of the lens 20. The wavelength of the irradiation light from the semiconductor light source 10 is converted through the wavelength conversion member 30. Accordingly, the irradiation light travels toward an emission opening of the holder 40.

In this way, an opening portion (aperture) 40a is formed between the lens 20 and the wavelength conversion member 30 inside the cylindrical holder 40.

### Configuration of Holder 40

It is desirable that the holder 40 is formed of a material having a high thermal conductivity. A material that is lightweight, has a high thermal conductivity, and is easy to process, such as aluminum, can be suitably used for the holder 40. In addition, the holder 40 is not limited to aluminum, and may be formed of a metal or non-metal material having a thermal conductivity of 10 W/mK or more, more preferably 80 W/mK or more.

On an inner wall of the holder 40 between the lens 20 and the wavelength conversion member 30, a first step portion 40c that covers an outer edge of the wavelength conversion member 30 as seen from the lens 20 side is included. In other words, in the light emitting device 100, the first step portion 40c is formed such that the wavelength conversion member 30 can enter a cylindrical space formed by the first step portion 40c. In addition, the first step portion 40c is also referred to as a wavelength conversion member support portion that supports the wavelength conversion member 30. A wavelength conversion member support portion 40c projects inside the holder 40 and is provided in a step shape inside. It is desirable that the wavelength conversion member support portion 40c projects in a ring shape along a circumferential direction inside the holder 40.

According to the above configuration, it is possible to obtain the light emitting device 100 capable of reducing an yellow ring by forming the opening portion (aperture) 40a between the lens 20 and the wavelength conversion member 30 inside the cylindrical holder 40 and by transmitting only a part of a laser light from the semiconductor light source 10 and having a mixed color region.

In addition, as shown in FIGS. 1A to 1C, the inner wall of the holder 40 includes a second step portion 40b that covers an outer edge of the lens 20 as seen from the semiconductor light source 10 side. In other words, in the light emitting device 100, the second step portion 40b is formed such that the lens 20 can enter a cylindrical space formed by the second step portion 40b. The second step portion 40b is also referred to as a lens support portion that supports the lens 20. A lens support portion 40b projects inside the holder 40 and is provided in a step shape inside. It is desirable that the lens support portion 40b desirably projects in the ring shape along the circumferential direction inside the holder 40.

According to the above configuration, it is possible to reliably obtain the light emitting device 100 capable of reducing the yellow ring by forming the second step portion 40b inside the cylindrical holder 40, by suitably forming the opening portion (aperture) 40a between the second step portion 40b and the first step portion 40c while being able to support the lens 20, and by transmitting only the part of the laser light from the semiconductor light source 10 and having the mixed color region.

As described above, in the light emitting device 100, the lens 20 and the wavelength conversion member 30 are disposed inside the holder 40. In addition, the wavelength conversion member 30 is fixed to the wavelength conversion member support portion 40c using a fixing resin 80. Alternatively, the holder and the wavelength conversion member can be fixed to each other using a metal bump such as a gold bump or an Sn—Au—Cu solder material after metalizing an outer circumferential portion of the wavelength conversion member by metal vapor deposition or the like. Moreover, since a low melting point glass is melted by disposing a ring-shaped low melting point glass between the holder and the wavelength conversion member and treating it in an appropriate temperature range between 300 and 1000 degrees, it is also possible to fix the holder and the wavelength conversion member via the low melting point glass.

The wavelength conversion member 30 is secured to a step surface of the wavelength conversion member support portion 40c on the side facing the semiconductor light source 10 in the holder 40. Thereby, even in a case where the wavelength conversion member 30 falls from the wavelength conversion member support portion 40c, the wavelength conversion member 30 remains in luminous flux of the irradiation light from the semiconductor light source 10. Therefore, since the laser light from the semiconductor light source 10 is not directly emitted without passing through the wavelength conversion member 30, safety can be improved. In a case where the wavelength conversion member 30 falls, the light emitting device 100 is arranged in consideration of a diameter of the wavelength conversion member 30 to block laser emission light of the semiconductor light source 10. Therefore, the light emitting device 100 has excellent safety.

Also, although the illustration is omitted, the wavelength conversion member support portion 40c is configured with a pair of steps that projects from inside the holder 40 and faces each other, and may have a configuration that supports the wavelength conversion member 30 inside by pinching the wavelength conversion member 30 between the pair of steps.

The lens 20 is fixed to the lens support portion 40b using the fixing resin 80.

The lens 20 is secured to the step surface of the lens support portion 40b on the emission opening side of the holder 40. Also, although the illustration is omitted, the lens support portion 40b is configured with a pair of steps that projects from inside the holder 40 and faces each other, and may have a configuration that supports the lens 20 inside by pinching the lens 20 between the pair of steps. As shown in FIGS. 1A to 1C, the semiconductor light source 10 is pinched and supported between a light source support portion (not shown) in the holder 40 and the heat radiating plate 60 that closes an opening of the holder 40 on the semiconductor light source side.

According to the above configuration, in the light emitting device 100, the wavelength conversion member 30 and the lens 20 can be suitably fixed to the first step portion 40c and the second step portion 40b with the fixing resin 80, respectively.

Furthermore, a groove for adjusting an amount of the fixing resin 80 may be provided in the first step portion 40c and the second step portion 40b. As shown in FIGS. 1A to 1C, a groove 40e may be recessed in the second step portion 40b toward a radial direction at a position corresponding to the fixing resin 80 of the second step portion 40b (refer to FIG. 1B), and or may be recessed in the second step portion 40b toward a downward direction below a position of the fixing resin 80 of the second step portion 40b (refer to FIG. 1C). Accordingly, the wavelength conversion member 30 and the lens 20 can be more suitably fixed.

The housing 50 is a member that secures the holder 40. Specifically, the housing 50 is desirably disposed to enclose the holder 40. Therefore, since a side surface of the holder 40 and the housing 50 are configured to come into contact with each other, it is possible to provide the light emitting device 100 that is excellent in heat dissipation, can improve heat radiation of the light emitting device 100, and has a high-output and a high reliability.

The housing 50 is also desirably made of a material having a high thermal conductivity. For the housing 50, a material that is lightweight, has a high thermal conductivity, and is easy to process, such as aluminum, can be suitably used. In addition, the housing 50 is not limited to aluminum, and may be formed of a metal or non-metal material having a thermal conductivity of 10 W/mK or more, more preferably 80 W/mK or more.

As shown in FIGS. 1A to 1C, the semiconductor light source 10 is mounted on a heat radiating plate 60 formed of a material having a high thermal conductivity, and a holder 40 and a housing 50 are fixed to the heat radiating plate 60.

The heat radiating plate 60 (plate) is a plate-shaped member formed from a material having a high thermal conductivity. For the heat radiating plate 60, for example, aluminum that is lightweight and has a high thermal conductivity can be suitably used. In addition, the heat radiating plate 60 is not limited to aluminum, and may be formed of a metal or non-metal material having a thermal conductivity of 10 W/mK or more, more preferably 80 W/mK or more.

The heat radiating plate 60 functions as a heat sink for the semiconductor light source 10 and absorbs heat from the semiconductor light source 10. Moreover, the heat radiating plate 60 is in contact with the holder 40 and the housing 50 formed of a material having a high thermal conductivity.

In this way, the semiconductor light source 10 is mounted on the heat radiating plate 60 formed of the material having the high thermal conductivity, and the heat radiating plate 60 is brought into contact with the holder 40 and the housing 50 formed of the material having the high thermal conductivity. Accordingly, the heat from the semiconductor light source 10 can be efficiently radiated from the heat radiating plate 60, the holder 40, and the housing 50. Accordingly, even in a case where the output of the semiconductor light source 10 is increased, the heat can be radiated efficiently, and performance and life of the semiconductor light source 10 can be kept from being affected by heat. Additionally, a heat radiating structure such as a fin may be appropriately provided on an outer periphery of the housing 50.

### Configuration of Semiconductor Light Source 10

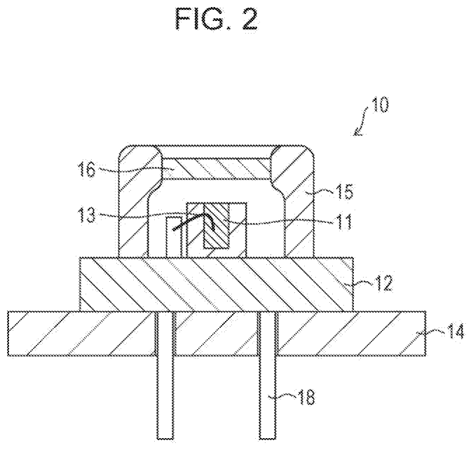

FIG. 2 is a schematic diagram of a configuration of the semiconductor light source 10. As shown in FIG. 2, the semiconductor light source 10 includes a semiconductor laser chip 11 (semiconductor light emitting element). The semiconductor laser chip 11 is a semiconductor laser element having an emission peak wavelength in a range of 360 nm to 800 nm. The semiconductor light source 10 is desirably a TO-CAN package type laser light source. The semiconductor laser chip 11 of the first embodiment is a blue semiconductor laser chip that irradiates blue light, and the semiconductor laser chip 11 is referred to as a blue semiconductor laser chip 11.

The semiconductor light source 10 includes a stem 12 mounted on an LD plate 14 that is a semiconductor light source substrate, and the blue semiconductor laser chip 11 is coupled to a wire 13 (leads) extending from the stem 12. As a method for mounting the stem 12 on the LD plate 14, a fusion or welding method may be mentioned.

The semiconductor light source 10 includes a can 15 that covers a periphery of the blue semiconductor laser chip 11 and has a metal cap shape. A light-transmitting plate 16 (cover glass) that transmits the irradiation light from the blue semiconductor laser chip 11 is provided in an irradiation opening of the can 15. In addition, a pin 18 extending from the stem 12 extends through the LD plate 14. The blue semiconductor laser chip 11 emits light in a case where power supplied from the pin 18 to the wire 13 is applied.

In the semiconductor light source 10, the LD plate 14 is mounted on the heat radiating plate 60, and heat from the blue semiconductor laser chip 11 is transferred to the heat radiating plate 60 via the LD plate 14 (refer to FIGS. 1A to 1C). A hole through which the pin 18 extending from the stem 12 passes is formed in the heat radiating plate 60, and an external power is coupled to the pin 18 exposed via the hole.

### Configuration of Wavelength Conversion Member 30

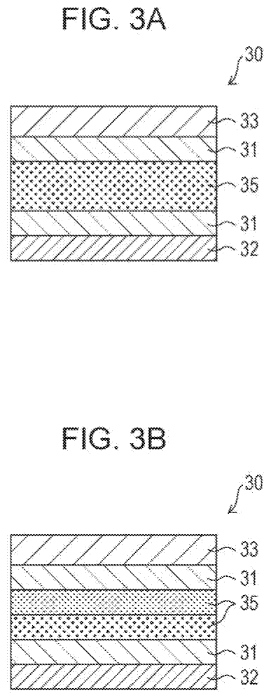

FIGS. 3A and 3B are cross-sectional diagrams schematically showing the wavelength conversion member 30, and FIG. 3A is an example and FIG. 3B is another example.

As shown in FIGS. 3A and 3B, the wavelength conversion member 30 has a plurality of layers laminated in a cross-sectional view. In the first embodiment, the wavelength conversion member 30 is formed with a thickness of 2 mm. The wavelength conversion member 30 is configured, for example, by laminating a glass layer 31, a wavelength selective layer 32, a phosphor layer 35, and an antireflection layer 33 formed of sapphire glass as a substrate.

As an example, the wavelength conversion member 30 may be a material obtained by solidifying a phosphor using an inorganic material containing at least one of glass, SiO₂, AlN, ZrO₂, SiN, Al₂O₃, and GaN as a binder.

As another example, the wavelength conversion member 30 may be a member obtained by mounting a mixture of a phosphor and an organic binder or an inorganic binder on a support base transparent to visible light and made of an inorganic material containing at least one of glass, SiO₂, AlN, ZrO₂, SiN, Al₂O₃, and GaN.

As still another example, the wavelength conversion member 30 may be a plate-shaped member made of only a phosphor.

The phosphor in the wavelength conversion member 30 is, for example, a blue phosphor, a green phosphor, a yellow phosphor, or a red phosphor, and the wavelength conversion member 30 includes the phosphor layer 35 that contains a phosphor of at least one selected from the group consisting of Ce-activated Ln₃(Al₁₋ₓGaₓ) O₁₂ (Ln is selected from at least one of Y, La, Gd, and Lu, and Ce substitutes for Ln), Eu, Ce-activated Ca₃(ScₓMg₁₋ₓ)₂Si₃O₁₂ (Ce substitutes for Ca), Eu-activated (Sr₁₋ₓCaₓ)AlSiN₃ (Eu substitutes for Sr and Ca), Ce-activated (La₁₋ₓYₓ)₃Si₆N₁₁ (Ce substitutes for La and Y), Ce-activated Ca-α-Sialon, Eu-activated β-Sialon, and Eu-activated M₂Si₅N₈ (M is selected from at least one of Ca, Sr, and Ba, and Eu substitutes for M). The wavelength conversion member 30 may include a plurality of phosphors, and light emitting efficiency and color rendering property can be improved by combining the phosphors. For example, in a case where it is desired to emit white light, it is possible to improve the light emitting efficiency by using a blue light emitting semiconductor laser chip and a phosphor that emits yellow light, and it is possible to improve the color rendering property by using a combination of the blue light emitting semiconductor laser chip, the phosphor that emits the yellow light, a phosphor that emits green light, or a phosphor that emits red light.

As shown in FIGS. 3A and 3B, the phosphor layer 35 is configured to include one or more of phosphors. For example, as shown in FIG. 3B, the phosphor layer 35 may be configured to laminate a phosphor layer having a small particle diameter and a phosphor layer having a large particle diameter. In addition, the phosphor layer 35 is pinched between the glass layers 31.

An antireflection layer 33 laminated on the glass layer 31 is formed on a light emission surface of the wavelength conversion member 30. The antireflection layer 33 blocks reflection of excitation light excited in the phosphor layer 35.

The wavelength selective layer 32 laminated on the glass layer 31 is formed on a light incident surface of the wavelength conversion member 30. The wavelength selective layer 32 is configured by a dichroic mirror and transmits only light in a blue wavelength range.

In this way, the wavelength conversion member 30 can emit only the light in the blue wavelength range which is the irradiation light from the semiconductor light source 10 and selected by the wavelength selective layer 32, by being excited in the phosphor layer 35. Since the phosphor layer 35 includes the phosphor layer having a small particle diameter and the phosphor layer having a large particle diameter, the phosphor layer 35 is excited by the laser light having the emission peak wavelength in a range of 360 nm to 800 nm and emits white light that has a high color rendering property.

In addition, as described above, the wavelength conversion member 30 in the present embodiment may include at least one of a yellow phosphor, a green phosphor, and a red phosphor. Each phosphor may be a single layer or a laminated structure.

Furthermore, in the wavelength conversion member 30 in the present embodiment, phosphors and inorganic binders having different particle size distributions may be mixed. By combining a major phosphor with a phosphor or an inorganic particle having a smaller particle size, a denser phosphor plate can be used as a material for a phosphor plate having higher thermal conductivity. For example, a median diameter of the major phosphor is desirably 10 um or more and 30 um or less, and a median diameter of the phosphor having a small particle size is desirably 1 um or more and 8 um or less. Thereby, it is possible to suitably improve that heat radiation at a phosphor portion in the transmissive wavelength conversion member has been one major issue.

In addition, other than the above configuration, the wavelength conversion member 30 in the present embodiment may contain a filler (not shown). As the filler content increases, light spread by the filler increases. Accordingly, as an effective optical path length increases, a light conversion amount at the wavelength conversion member 30 increases. Therefore, it can contribute to wavelength conversion performance of the wavelength conversion member 30.

### Method for Manufacturing Light Emitting Device 100

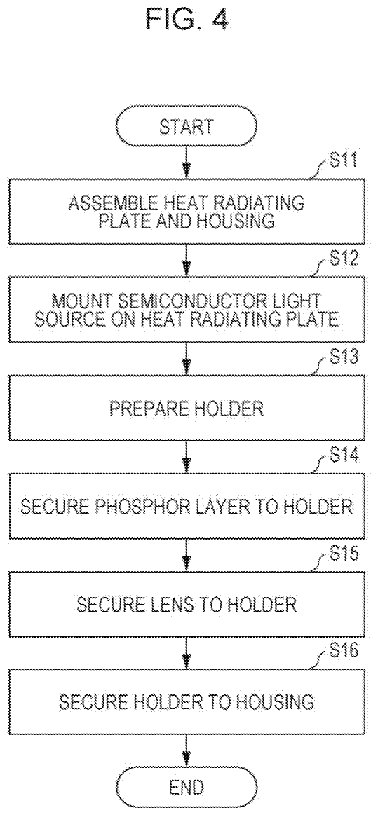

FIG. 4 is a flowchart of a method for manufacturing the light emitting device 100. As shown in FIG. 4, first, in step S11, the housing 50 is assembled to the heat radiating plate 60. Next, in step S12, the semiconductor light source 10 is mounted on the heat radiating plate 60. Next, in step S13, a holder 40 provided with a first step portion 40c, a second step portion 40b, and an opening portion 40a in advance is prepared.

Next, in step S14, the wavelength conversion member 30 (phosphor layer) is fixed (secured) to the wavelength conversion member support portion 40c of the holder 40. Next, in step S15, the lens 20 is fixed (secured) to the lens support portion 40b of the holder 40. Next, in step S16, the holder 40 is secured to the housing 50. In the present embodiment, order of step S15 and step S16 may be reversed.

In this way, the light emitting device 100 includes the wavelength conversion member support portion 40c, the lens support portion 40b, and the light source support portion (not shown) inside the holder 40, and the wavelength conversion member 30, the lens 20, and the semiconductor light source 10 are respectively supported and secured to the wavelength conversion member support portion 40c, the lens support portion 40b, and the light source support portion (not shown). Thereby, at the time of an assembly of the light emitting device 100, an optical axis of the lens 20, the wavelength conversion member 30, and the semiconductor light source 10 can be easily aligned, and the manufacturing work can be performed efficiently.

### Second Embodiment

A second embodiment of the present disclosure is described below. For the sake of convenience of explanation, members having the same function as members described in the first embodiment above-described are given the same reference sign, and thus description thereof will not be repeated.

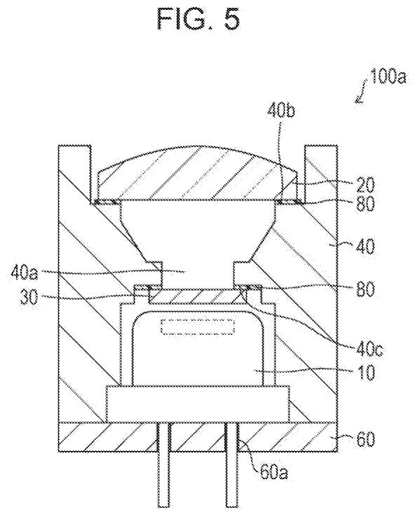

FIG. 5 is a cross-sectional diagram of a configuration of a light emitting device 100a according to the second embodiment. Compared with the light emitting device 100 according to the first embodiment, major difference is that the light emitting device 100a does not include a housing. Thereby, since the number of parts can be reduced, manufacturing cost of the light emitting device 100a can be reduced. Hereinafter, a description will be made mostly of the difference.

In the light emitting device 100a, a thickness of a part which is a part of the holder 40 and surrounds the can 15 (refer to FIG. 2) of the semiconductor light source 10 is thicker than a thickness of a corresponding portion of the light emitting device 100. Thereby, it is favorable to radiate heat from the semiconductor light source 10.

Furthermore, in the light emitting device 100a, the structure of a portion of the holder 40 that surrounds the can 15 (refer to FIG. 2) of the semiconductor light source 10 is simplified. Accordingly, it can contribute to the machining cost reduction of the holder 40.

Also in the embodiment, the wavelength conversion member 30 may include at least one of a yellow phosphor, a green phosphor, and a red phosphor. Each phosphor may be a single layer or a laminated structure.

The light emitting device 100a according to the present embodiment can achieve the same effects as the light emitting device 100 according to the first embodiment. Method for Manufacturing Light Emitting Device 100a

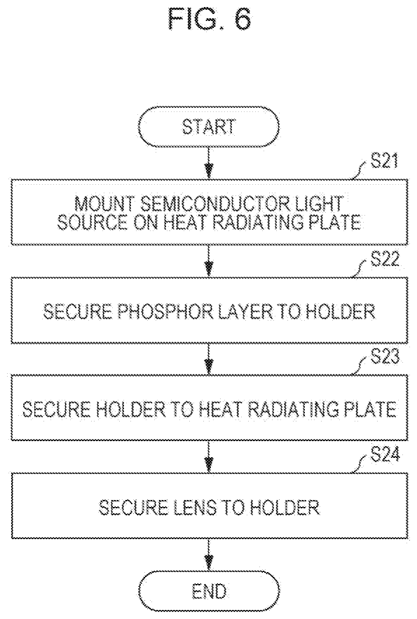

FIG. 6 is a flowchart of a method for manufacturing the light emitting device 100a. As shown in FIG. 6, first, in step S21, the semiconductor light source 10 is mounted on the heat radiating plate 60 via the through-hole 60a (refer to FIG. 5) of the heat radiating plate 60. Next, in step S22, the wavelength conversion member 30 (phosphor layer) is fixed (secured) to the wavelength conversion member support portion 40c of the holder 40. Next, the holder 40 is secured to the heat radiating plate 60 in step S23. Next, in step S24, the lens 20 is fixed (secured) to the lens support portion 40b of the holder 40.

### Third Embodiment

A third embodiment of the present disclosure is described below. For the sake of convenience of explanation, members having the same function as members described in the first embodiment or the second embodiment described above are given the same reference sign, and thus description thereof will not be repeated.

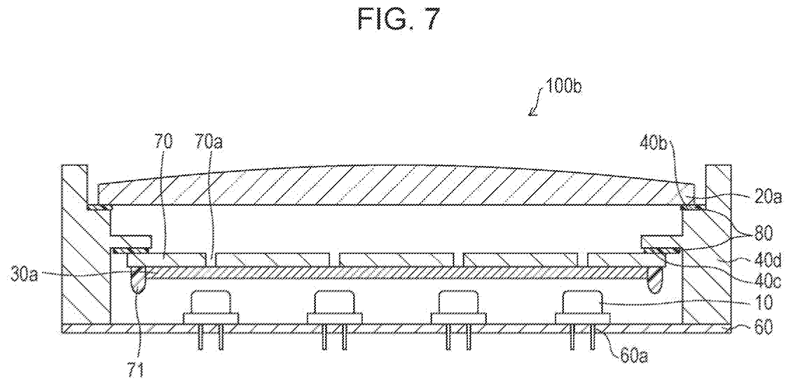

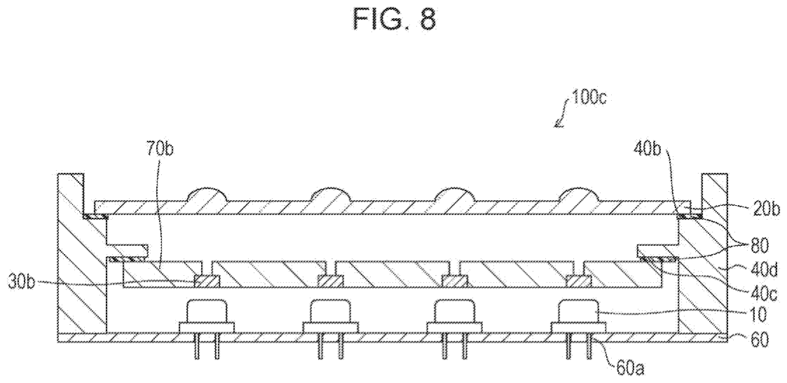

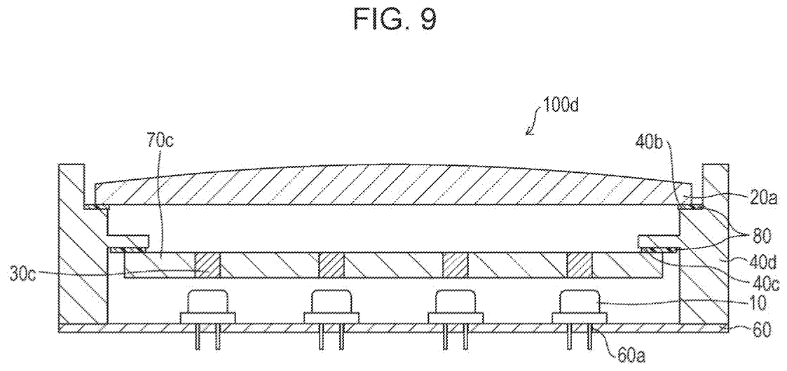

In the first embodiment or the second embodiment described above, the light emitting device including a single semiconductor light source 10 has been described. However, in the present embodiment, a light emitting device including a plurality of semiconductor light sources 10 will be described. FIG. 7 is a cross-sectional diagram of an example of the light emitting device according to the present embodiment. FIG. 8 is a cross-sectional diagram of another example of the light emitting device. FIG. 9 is a cross-sectional diagram of still another example of the light emitting device.

### Configuration of Light Emitting Device 100b

As shown in FIG. 7, a light emitting device 100b includes a plurality of semiconductor light sources 10, a lens 20a, a wavelength conversion member 30a, a holder 40d, a heat radiating plate 60 including a through-hole 60a, a wavelength conversion member mounting plate 70 including a through-hole 70a, and a resin dam 71. The plurality of semiconductor light sources 10, the lens 20a, and the wavelength conversion member 30a are disposed inside a cylindrical holder 40d.

Similar to the lens 20, the lens 20a is also an optical member that concentrates the irradiation light from the semiconductor light source 10 and emits the light to the outside. As the lens 20a, a biconvex lens can be suitably used.

Similar to the wavelength conversion member 30, the wavelength conversion member 30a also converts the wavelength of the irradiation light from the semiconductor light source 10. In the light emitting device 100b, the wavelength conversion member 30a is surrounded by the resin dam 71 and mounted on the wavelength conversion member mounting plate 70.

As shown in FIG. 7, the through-hole 70a is formed at locations corresponding to the plurality of semiconductor light sources 10 on the wavelength conversion member mounting plate 70. Accordingly, the laser light from the plurality of semiconductor light sources 10 can be emitted to the outside of the light emitting device 100b.

As shown in FIG. 7, in the light emitting device 100b, the lens 20a and the wavelength conversion member 30a are disposed inside the holder 40d. The wavelength conversion member 30a is fixed to the wavelength conversion member support portion 40c using the fixing resin 80. Furthermore, the lens 20a is fixed to the lens support portion 40b using the fixing resin 80.

According to the above configuration, the light emitting device 100b can achieve the same effect as the light emitting device according to the embodiment described above, and high-output can be achieved by increasing the size.

### Configuration of Light Emitting Device 100c

As shown in FIG. 8, a light emitting device 100c includes a plurality of semiconductor light sources 10, a lens 20b, a plurality of wavelength conversion members 30b, a holder 40d, a heat radiating plate 60 including a through-hole 60a, and a wavelength conversion member mounting plate 70b including a through-hole.

Compared to the light emitting device 100b, the light emitting device 100c is different in the structure of the lens 20b and the wavelength conversion member mounting plate 70b. Hereinafter, a description will be made mostly of the difference. As shown in FIG. 8, through-holes are formed at positions corresponding to the plurality of semiconductor light sources 10 on the wavelength conversion member mounting plate 70b. Furthermore, the plurality of wavelength conversion members 30b are inserted into the plurality of through-holes from the semiconductor light source 10 side, respectively. Therefore, the laser light from the plurality of semiconductor light sources 10 can be emitted to the outside of the light emitting device 100c.

In addition, in the light emitting device 100c, raised portions are formed at positions corresponding to the plurality of semiconductor light sources 10 and the plurality of wavelength conversion members 30b of the lens 20b. Accordingly, the lens 20b can concentrate the irradiation light from the semiconductor light source 10 corresponding to the plurality of raised portions and emit the light to the outside of the light emitting device 100c.

According to the above configuration, the light emitting device 100c can achieve the same effect as the light emitting device 100b.

### Configuration of Light Emitting Device 100d

As shown in FIG. 9, a light emitting device 100d includes a plurality of semiconductor light sources 10, a lens 20a, a plurality of wavelength conversion members 30c, a holder 40d, a heat radiating plate 60 including a through-hole 60a, and a wavelength conversion member mounting plate 70c including a through-hole.

Compared with the light emitting device 100c, the light emitting device 100d is different in the structure of the lens 20a (refer to FIG. 7) and the wavelength conversion member mounting plate 70c. Hereinafter, a description will be made mostly of the difference. As shown in FIG. 9, through-holes are formed at locations corresponding to the plurality of semiconductor light sources 10 on the wavelength conversion member mounting plate 70c. Further, the plurality of wavelength conversion members 30c are respectively inserted into the plurality of through-holes to be flush with the upper and lower surfaces of the wavelength conversion member mounting plate 70c. Accordingly, the laser light from the plurality of semiconductor light sources 10 can be emitted to the outside of the light emitting device 100d.

According to the above configuration, the light emitting device 100d can achieve the same effect as the light emitting device 100b and the light emitting device 100c.

### Arrangement Example of Semiconductor Light Source of Light Emitting Devices 100b to 100d and Configuration of Wavelength Conversion Member

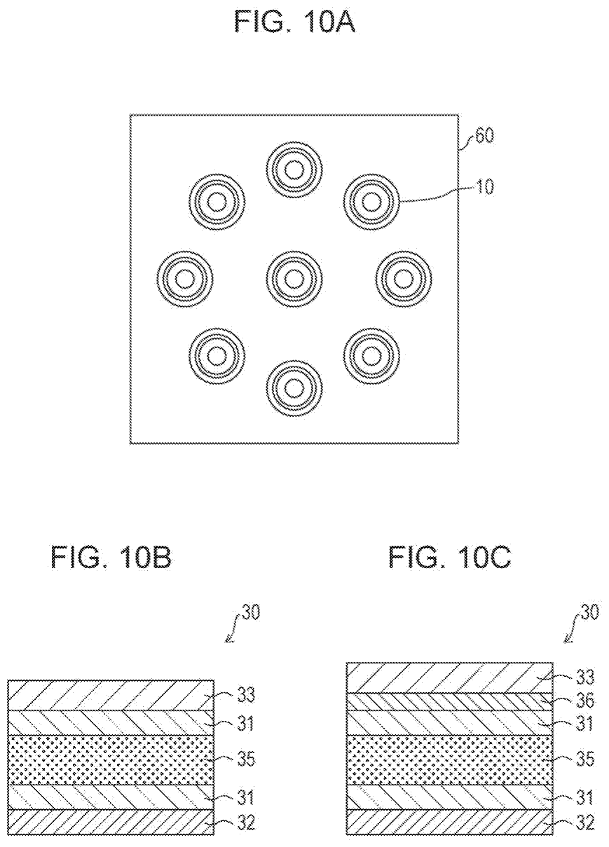

FIG. 10A is a top view schematic diagram of the light emitting devices 100b to 100d, FIG. 10B is an example of a cross-sectional diagram schematically showing the wavelength conversion members 30a to 30c, and FIG. 10C is another example.

As shown in FIG. 10A, in the light emitting devices 100b to 100d described above, it is desirable that the plurality (9 in FIGS.) of the semiconductor light sources 10 are disposed in a circular shape such that a distance between neighbors are substantially equal, for example. The closer the distance between the light sources, the closer to a point light source. Therefore, the design of an optical system becomes easy. On the other hand, in a case of using a microlens array as shown in FIG. 8 or combining a plurality of lenses, the distance and positional relationship of the semiconductor light source 10 are suitable for lens design. However, the arrangement of the semiconductor light source 10 is not limited to the above, and in accordance with usage situation, may be changed as appropriate for optical reasons such as arrangement in a grid shape, and reasons such as thermal design, and housing design. For example, in a case where twelve semiconductor light sources 10 are disposed, it is not circular, but may be changed to three columns and four rows, or two rows and six columns, or the like, in accordance with a housing of a lighting device using the light emitting device.

As shown in FIG. 10B, a configuration of the wavelength conversion members 30a to 30c in the light emitting devices 100b to 100d may be, for example, the configuration shown in FIG. 3A according to the first embodiment. That is, the wavelength conversion members 30a to 30c are configured by laminating a glass layer 31, a wavelength selective layer 32, a phosphor layer 35, and an antireflection layer 33 formed of sapphire glass as a substrate.

As another example of the configuration of the wavelength conversion members 30a to 30c, for example, as shown in FIG. 10B, a color filter 36 may be further provided between the antireflection layer 33 and the glass layer 31 adjacent to the antireflection layer 33. The color filter 36 is a layer that mostly transmits light emitted from the wavelength conversion members 30a to 30c.

The wavelength conversion members 30a to 30c in the present embodiment can also achieve the same effects as the wavelength conversion member 30 in the first embodiment or the second embodiment.

Also in the present embodiment, the wavelength conversion members 30a to 30c may include at least one of a yellow phosphor, a green phosphor, or a red phosphor. Each phosphor may be a single layer or a laminated structure.

### Modification Example of Wavelength Conversion Member

The wavelength conversion member is not limited to a structure of the wavelength conversion members 30a to 30c described above, and may have the following structure.

The wavelength conversion member may be a plate-shaped member made of only a phosphor, and for example,

a member that a single crystal phosphor is cut into a plate-shape,

a member that phosphor particles are sintered into a plate-shape,

a member that phosphor particles and particles having light scattering function are mixed and sintered into a plate-shape,

a member that phosphor particles are compression-molded into a plate-shape,

a member that phosphor particles and light scattering particle are mixed and compression-formed, or

a member that the phosphor particles are coated and formed in a layer-shape on a substrate transparent formed of sapphire, glass, or the like, using an organic binder or inorganic binder can be used. In addition, the phosphor layer in the wavelength conversion member 30a to 30c and the wavelength conversion member having the simple structure described above may have voids depending on the formation method thereof. Therefore, light scattering is affected, and the light scattering increases as the amount of voids increases. Furthermore, the wavelength conversion member may be the structure of the wavelength conversion members 30a to 30c or a combination of a plurality of the above structures.

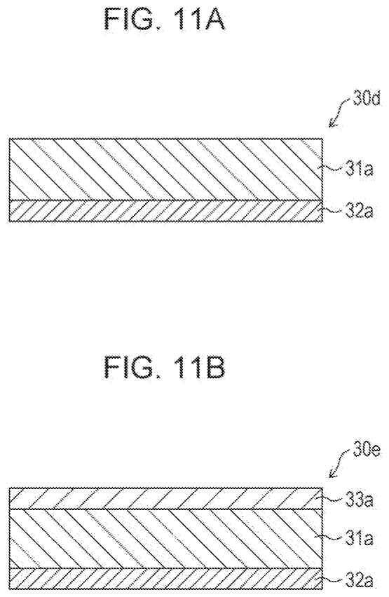

FIGS. 11A and 11B are diagrams of configurations of wavelength conversion members 30d and 30e which are modification examples.

As shown in FIG. 11A, the wavelength conversion member 30d may be a member that forms a wavelength selective light-reflecting region 32a having such a characteristic that reflects a phosphor light, on an incident side of light from a laser of a plate-shaped member 31a made of only the phosphor described above. The light-reflecting region 32a can be configured with the dichroic mirror.

Furthermore, as shown in FIG. 11B, the wavelength conversion member 30e may also form the dichroic mirror or a wavelength selective light-absorbing color filter layer 33a, which have characteristics that reflect light from a laser of either the plate-shaped member (phosphor plate) 31a made of only the phosphor or a member (31a+32a) in which the light-reflecting region 32a is formed on the plate-shaped member 31a made of only the phosphor, on a light emission side from the laser. A design of reflectivity of the dichroic mirror or transmitting spectral characteristic of the color filter is appropriately changed in accordance with a desired characteristic of spectra of the light emitted from the semiconductor light source device.

The wavelength conversion member may be a member that forms the light scattering layer on the incident side of the light from the laser, or on both the incident side and the emission side of the light from the laser of the plate-shaped member made of only the phosphor.

In addition, in order to suppress in-plane guided in the member of the plate-shaped member made of only the phosphor, the wavelength conversion member may have a configuration which includes a reflection film or a reflective layer formed by a metal film or a dichroic mirror, or the like on both sides of the phosphor plate. In this way, light extraction efficiency from the emission surface of the wavelength conversion member can be improved by providing the reflection film or the reflective layer on both sides of the phosphor plate.

### Method for Manufacturing Light Emitting Device 100b to 100d

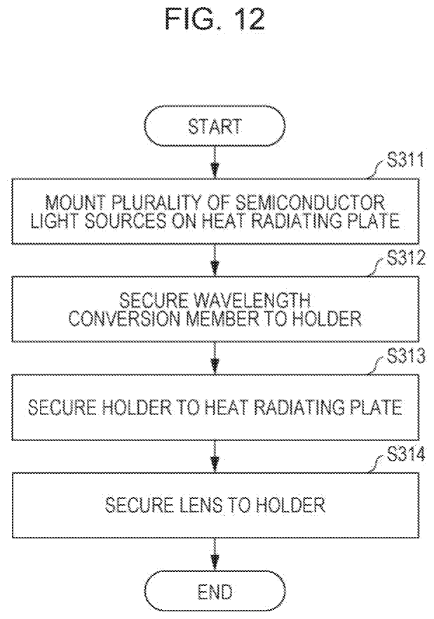

FIG. 12 is a flowchart of a method for manufacturing the light emitting devices 100b to 100d. As shown in FIG. 12, first, in step S311, the plurality of semiconductor light sources 10 are mounted on the heat radiating plate 60 via the through-hole 60a of the heat radiating plate 60 (refer to FIGS. 7 to 9). Next, in step S312, the wavelength conversion members 30a to 30c are respectively fixed (secured) to the wavelength conversion member support portion 40c of the holder 40d. Next, in step S313, the holder 40d is secured to the heat radiating plate 60. Next, in step S314, the lenses 20 to 20a are fixed (secured) to the lens support portion 40b of the holder 40.

### Method for Manufacturing Wavelength Conversion Member 30a

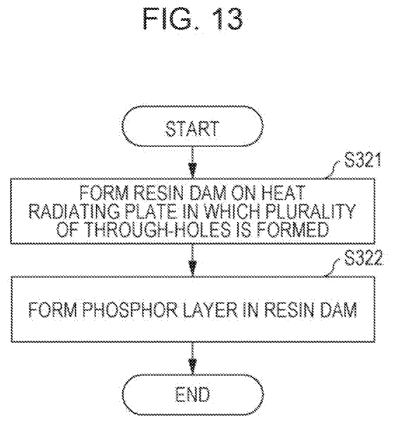

FIG. 13 is a flowchart of a method for manufacturing the wavelength conversion member 30a. As shown in FIG. 13, first, in step S321, the resin dam 71 is formed on the wavelength conversion member mounting plate 70 (heat radiating plate) in which a plurality of through-holes 70a are formed. Next, in step S322, the wavelength conversion member 30a (phosphor layer) is formed in the resin dam 71.

The present disclosure is not limited to the above-described embodiments, and various modifications are possible within the scope disclosed in the claims. In addition, embodiments obtained by appropriately combining technical methods respectively disclosed in different embodiments are also included in the technical scope of the present disclosure. Furthermore, a new technical feature can be formed by combining the technical methods respectively disclosed in each embodiment.

The present disclosure contains subject matter related to that disclosed in U.S. Provisional Patent Application No. 62/808,568 filed in the US Patent Office on Feb. 21, 2019, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A light emitting device comprising at least:
a lens that emits light to the outside;
a holder that supports the lens; and
a wavelength conversion member and a semiconductor light source that are disposed inside the holder and a semiconductor light source on a side opposite to an emission surface of the lens,
wherein an inner wall of the holder between the lens and the wavelength conversion member includes a first step portion that covers an outer edge of the wavelength conversion member as seen from the lens side.

2. The light emitting device according to claim 1,
wherein the inner wall of the holder includes a second step portion that covers an outer edge of the lens as seen from the semiconductor light source side.

3. The light emitting device according to claim 2,
wherein the lens and the wavelength conversion member are disposed inside the holder,
wherein the wavelength conversion member is fixed to the first step portion by a fixing resin, and
wherein the lens is fixed to the second step portion by a fixing resin.

4. The light emitting device according to claim 1, further comprising:
a heat radiating plate,
wherein the semiconductor light source is disposed on the heat radiating plate, and the holder is fixed to the heat radiating plate.

5. The light emitting device according to claim 2,
wherein a groove for adjusting a fixing resin amount is provided in the first step portion and the second step portion.

6. The light emitting device according to claim 1,
wherein the wavelength conversion member is a member obtained by solidifying a phosphor using an inorganic material containing at least one of glass, SiO₂, AlN, ZrO₂, SiN, Al₂O₃, and GaN as a binder, or
a member obtained by mounting a mixture of a phosphor and an organic binder or an inorganic binder on a support base transparent to visible light and made of an inorganic material containing at least one of glass, SiO₂, AlN, ZrO₂, SiN, Al₂O₃, and GaN, or
a plate-shaped member made of only a phosphor.

7. The light emitting device according to claim 1,
wherein a semiconductor light emitting element mounted on the semiconductor light source is a semiconductor laser element having an emission peak wavelength in a range of 360 nm to 800 nm.

8. The light emitting device according to claim 6,
wherein the phosphor is a blue phosphor, a green phosphor, a yellow phosphor, or a red phosphor, and includes at least one selected from the group consisting of Ce-activated Ln₃(Al₁₋ₓGaₓ)₅O₁₂ (Ln is selected from at least one of Y, La, Gd, and Lu, and Ce substitutes for Ln), Eu, Ce-activated Ca₃(ScₓMg₁₋ₓ₎₂Si₃O₁₂ (Ce substitutes for Ca), Eu-activated (Sr₁₋ₓCaₓ)AlSiN₃ (Eu substitutes for Sr and Ca), Ce-activated (La₁₋ₓYₓ)₃Si₆N₁₁ (Ce substitutes for La and Y), Ce-activated Ca-α-Sialon, Eu-activated β-Sialon, and Eu-activated M₂Si₅N₈(M is selected from at least one of Ca, Sr, and Ba, and Eu substitutes for M).

9. The light emitting device according to claim 1,
wherein the wavelength conversion member contains a filler.
